(19) United States
(12) Patent Application Publication
(10) Pub. No.: US 2013/0069619 A1
(43) Pub. Date: Mar. 21, 2013

(54) INPUT DETECTION DEVICE

(71) Applicants: Tomokuni Wauke, Miyagi-ken (JP); Koichi Yamamoto, Miyagi-ken (JP)

(72) Inventors: Tomokuni Wauke, Miyagi-ken (JP); Koichi Yamamoto, Miyagi-ken (JP)

(21) Appl. No.: 13/619,129

(22) Filed: Sep. 14, 2012

(30) Foreign Application Priority Data
Sep. 20, 2011 (JP) 2011-204165

(51) Int. Cl. H01F 38/00

(52) U.S. Cl. 323/355

(57) ABSTRACT

When a first driving signal is applied from a waveform output unit, detection current with a high frequency than a natural frequency of a vibrator is applied to a coil of a vibration generation unit. When the current fluctuates, induction power due to a counter-electromotive force is inducted to a external casing of the vibration generation unit. The induction power is changed in an input unit, and when a level of an output due to the change thereof greatly fluctuates, a second driving signal is output from the waveform output unit, and logical sum of the first driving signal and the second driving signal is applied to a driving circuit. At this time, a vibration current flows to the coil, and the vibrator vibrates by the natural frequency.

### CLAIM OF PRIORITY

This application claims benefit of Japanese Patent Application No. 2011-204165 filed on Sep. 20, 2011, which is hereby incorporated by reference in its entirety.

### BACKGROUND

1. Field of the Disclosure

The present disclosure relates to an input detection device with which a comparatively large detection output can be obtained when an input unit is operated and with which both input detection and generation of vibrations can be performed using a common coil.

2. Description of the Related Art

An electrostatic capacitive sensor in which electrode units are respectively provided on the opposing portions of two substrates is disclosed in Japanese Unexamined Patent Application Publication No. 6-314163.

In the electrostatic capacitive sensor, when the distance between the opposing electrode units changes or the opposing area of the electrodes changes based on an operation of an input unit, the change is detected by a fluctuation in the electrostatic capacitance.

In the electrostatic capacitive sensor described in Japanese Unexamined Patent Application Publication No. 6-314163 and the like, since the fluctuation in the detection output with respect to a change in the distance between the electrodes or a change in the opposing area is extremely small, the electrostatic capacitive sensor is easily influenced by external noise, and it is difficult to detect miniscule changes with high accuracy.

Further, while the electrostatic capacitive sensor described in Japanese Unexamined Patent Application Publication No. 6-314163 and the like can obtain a detection output from operating the input unit, it is not possible for the sensor itself to generate vibrations for feedback or the like, and in order to generate vibrations, it is necessary to provide vibration generation means separately from the sensor.

### SUMMARY

An input detection device includes: a coil; a conductive induction member that is provided in proximity to the coil; a driving circuit that applies an alternating detection current to the coil; a detection circuit that detects the power that is inducted to the induction member by a counter-electromotive force when the detection current is applied to the coil; and an input unit that increases or decreases the power that is obtained from the induction member.

The input detection device of the present invention inducts the counter-electromotive force when an alternating detection current is applied to the coil to the induction member, and changes the inductive force using the input unit. It is thereby possible to extract a comparatively large change in the power when the input unit is operated, which improves detection precision and resistance to the influence of external noise.

### BRIEF DESCRIPTION OF THE DRAWINGS

FIG. 1 is an explanatory view that illustrates an input detection device of a first embodiment of the present invention;

FIG. 2 is an explanatory view that illustrates a modified example of the input detection device of the first embodiment;

FIG. 3 is a waveform view that illustrates the operation of the input detection device of the first embodiment;

FIG. 4 is an explanatory view that illustrates an input detection device of a second embodiment of the present invention;

FIG. 5 is a waveform view that illustrates the operation of the input detection device of the second embodiment;

FIG. 6 is another waveform view that illustrates the operation of the input detection device of the second embodiment;

FIG. 7 is a broken perspective view that illustrates an example of the structure of an input unit;

FIG. 8 is a cross-sectional view of the input unit illustrated in FIG. 7;

FIG. 9 is a broken perspective view that illustrates an input device that includes a plurality of input units;

FIG. 10 is a broken perspective view that illustrates another structure example of the input device that includes the plurality of input units;

FIG. 11 is a cross-sectional view of the input device illustrated in FIG. 10;

FIG. 12 is an explanatory view of the operation of the input units illustrated in FIGS. 10 and 11; and

FIG. 13 is a circuit configuration view of the input detection device including the input units illustrated in FIGS. 9 and 10.

### DESCRIPTION OF THE EXEMPLARY EMBODIMENTS

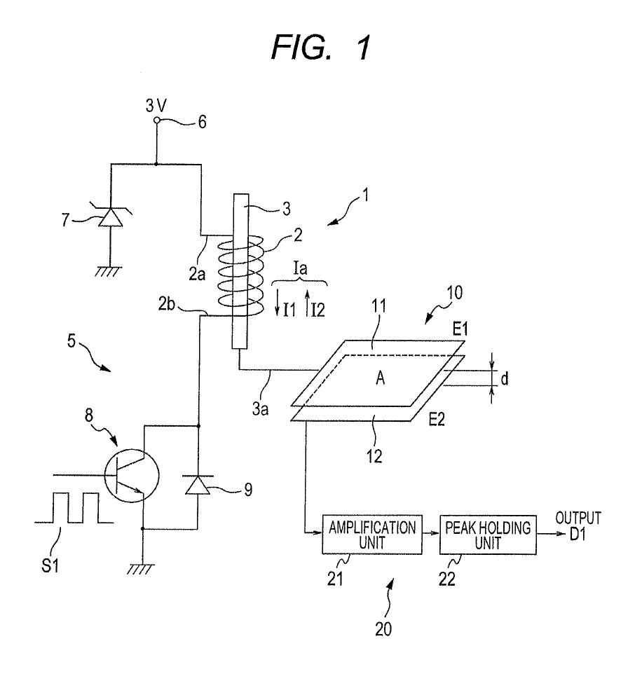

An input detection device 1 of a first embodiment illustrated in FIG. 1 includes a coil 2 and an induction member 3. The induction member 3 is a conductor, and is formed of a magnetic and conductive material such as an alloy with iron as the principal constituent, or of a non-magnetic and conductive material such as copper or an alloy with copper as the principal constituent. The coil 2 has wound wiring of which the surface has an insulation coating. The induction member 3 is provided in proximity with the coil 2. In the input detection device 1 illustrated in FIG. 1, the induction member 3 is inserted into the winding center of the coil 2. However, the induction member 3 may be arranged in proximity with the coil 2 to the outside of the coil 2.

A driving circuit 5 is provided to the input detection device 1. In the driving circuit 5, a first end portion 2a of the wiring that configures the coil 2 is connected to a connection terminal 6 to which a direct current of 3 V is applied. Further, a Zener diode 7 that is parallel with the coil 2 is provided so that the voltage that is applied to the coil 2 is stabilized.

A transistor 8 that functions as a switch element is provided on the driving circuit 5. A second end portion 2b of the wiring that configures the coil 2 is connected to a collector terminal of the transistor 8. A diode 9 for neutralizing the induction of power due to a counter-electromotive force in one direction is provided to the transistor 8.

An end portion of the induction member 3 is connected to an input unit 10 via a lead line 3a. The input unit 10 includes a first electrode 11 and a second electrode 12. The lead line 3a is connected to the first electrode 11. The first electrode 11 and the second electrode 12 are formed of a low-resistance conductive material such as a printed layer of a copper sheet, copper foil, or silver paste. The first electrode 11 and the second electrode 12 are both plate-like and face each other to be parallel with a distance therebetween, and in the input unit 10, at least one of a distance d and an facing area A of both electrodes 11 and 12 can be changed by an operating force from the outside.

A detection circuit 20 is connected to the second electrode 12. A voltage amplification unit 21 and a peak holding unit 22 are provided on the detection circuit 20.

The operation of the input detection device 1 will be described with reference to the waveform view of FIG. 3.

As illustrated in FIG. 1, a first driving signal S1 is provided to a base terminal of the transistor 8 that is provided on the driving circuit 5. The first driving signal S1 has a frequency of equal to or greater than 1 kHz, and is preferably set to a high frequency of approximately 10 kHz to 60 kHz. Using a switch function of the transistor 8, as illustrated in FIG. 3A, a detection current Ia with the same frequency as the first driving signal S1 flows through the coil 2. Depending on the current that flows between the collector and the emitter of the transistor 8, the detection current Ia that flows through the coil 2 is a comparatively large alternating current.

With the detection current Ia illustrated in FIG. 3A, a positive direction current I1 begins to flow from the first end portion 2a of the coil 2 toward the second end portion 2b at a startup time al and a reverse direction current 12 begins to flow from the second end portion 2b toward the first end portion 2a during a termination time a2. When the positive direction current I1 begins to flow through the coil 2, a counter-electromotive force is generated on the coil 2 from the second end portion 2b to the first end portion 2a. The current of the counter-electromotive force at this point short-circuits by flowing through the diode 9, thereby protecting the transistor 8.

While a counter-electromotive force is generated on the coil 2 from the first end portion 2a toward the second end portion 2b when the reverse direction current 12 begins to flow through the coil 2, since the conductive induction member 3 is in proximity with the coil 2, as illustrated in FIG. 3B, an induction power E1 that is synchronized with the counter-electromotive force at the termination time a2 of the detection current Ia is inducted to the induction member 3.

Since the size of the current that flows through the coil 2 is comparatively large, an induction power E1 with a large voltage of equal to or greater than 1 V or even equal to or greater than 2 V can be inducted to the induction member 3.

The induction power E1 that is inducted to the induction member 3 is led to the first electrode 11 of the input unit 10 via the lead line 3a. In the input unit 10, since the first electrode 11 and the second electrode 12 oppose each other with a narrow distance therebetween, a secondary induction power E2 with the same waveform is led to the second electrode 12 by the induction power E1 that is led to the first electrode 11. The secondary induction power E2 that is inducted to the second electrode 12 is amplified by the voltage amplification unit 21 of the detection circuit 20, and the peak value thereof is held by the peak holding unit 22. The holding value is updated when the peak value changes by a fixed range or greater.

A detection output D1 with which the peak value is held by the peak holding unit 22 is illustrated in FIG. 3C.

The detection output D1, that is, an output with which the peak value of the secondary induction power E2 is held is inversely proportional to the square of the opposing distance d between the first electrode 11 and the second electrode 12, and is proportional to the opposing area A of the first electrode 11 and the second electrode 12.

The opposing distance d is, for example, 5 to 100 μm, and the opposing area A is approximately 1 to 100 mm².

In the input detection device 1, when the first driving signal S1 with a fixed frequency is being applied to the driving circuit 5, by changing at least one of the opposing distance d and the opposing area A between the first electrode 11 and the second electrode 12 of the input unit 10 by operating an operation member (not shown), a detection output D1 that can change to reflect the operation state of the operation member at the input unit 10 can be obtained.

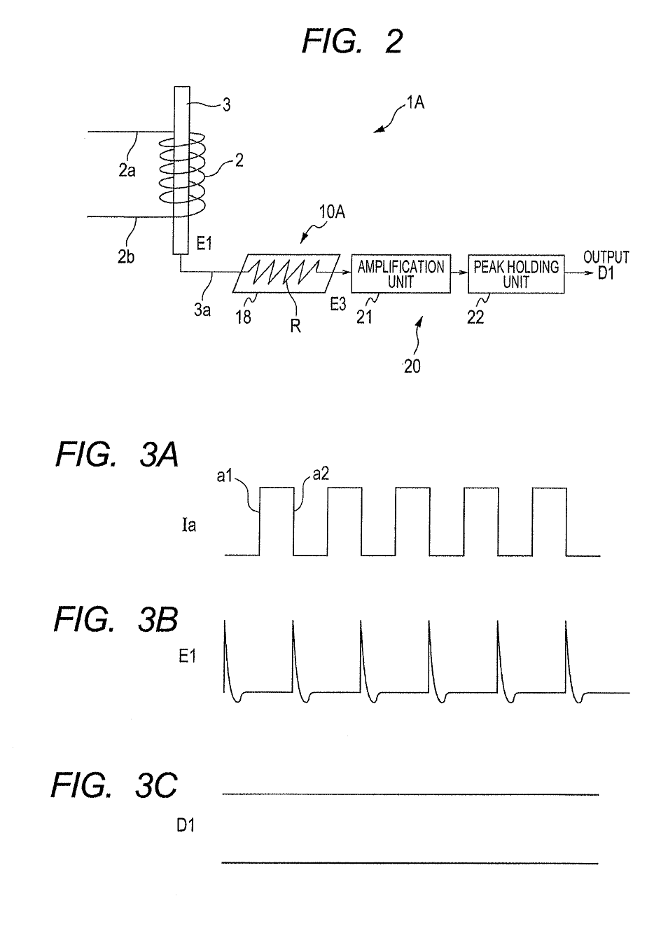

An input detection device 1A of a modified example illustrated in FIG. 2 includes a variable resistance type input unit 10A. The input unit 10A has a resistance layer R formed of a carbon layer or the like on the surface of a flexible or elastic sheet 18. One end portion of the resistance layer R is conductive with the induction member 3 via the lead line 3a, and the other end portion of the resistance layer R is connected to the voltage amplification unit 21 of the detection circuit 20.

In the input unit 10A, the resistance value of the resistance layer R is changed by the sheet 18 being bent or stretched by an operation member (not shown), and as a result, a variable induction power E3 in which the induction power E1 that is inducted to the induction member 3 is varied can be obtained. By amplifying and peak-holding the variable induction power E3, a detection output that reflects changes in the input unit 10A can be obtained.

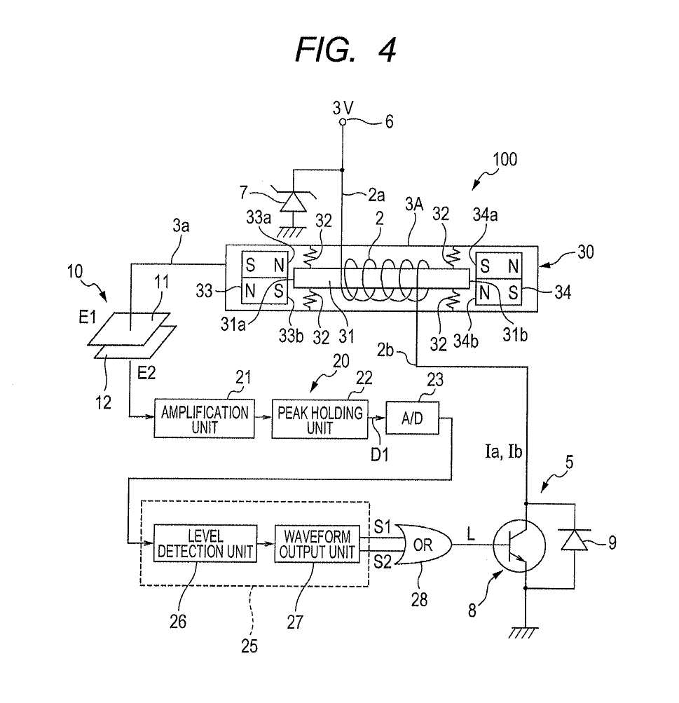

FIG. 4 illustrates an input detection device 100 of a second embodiment of the present invention. The input detection device 100 has the same symbols given to constituent portions that are the same as the input detection device 1 of the first embodiment illustrated in FIG. 1. Detailed description may be omitted for the portions to which the same symbols are given.

The input detection device 100 has the coil 2 for generating a counter-electromotive force configured as a portion of a vibration generation unit 30.

The vibration generation unit 30 includes an external casing 3A that contains the coil 2 and other constituent members. The exterior casing 3A is formed of a conductive metallic material, and exhibits the same functions as the induction member 3 illustrated in FIG. 1.

The vibration generation unit 30 has a vibrator 31 with a fixed mass on the inside of the exterior casing 3A. The vibrator 31 is formed by a soft magnetic material such as ferrite to be long and thin, and the coil 2 is wound around the outer circumference of the vibrator 31. The vibrator 31 is supported by an elastic support member 32 inside the exterior casing 3A so that the vibrator 31 is able to vibrate in the up and down direction in the drawing. The elastic support member 32 is formed of a leaf spring, a compression coil spring, or the like. The vibrator 31 has a natural frequency that is determined by the mass thereof, the mass of the coil, and the elastic coefficient of the elastic support member 32.

A pair of magnets 33 and 34 is provided on the inside of the exterior casing 3A. The magnet 33 opposes a left side end portion 31a of the vibrator 31, and the magnet 34 opposes a right side end portion 31b of the vibrator 31. The left side magnet 33 has an upper side opposing face 33a that is magnetized to the N pole and a lower side opposing face 33b that is magnetized to the S pole. The right side magnet 34 has an upper side opposing face 34a that is magnetized to the S pole and a lower side opposing face 34b that is magnetized to the N pole. That is, the left and right magnets 33 and 34 both have upper and lower portions that are magnetized to different magnetic poles, and between the magnet 33 and the magnet 34, different magnetic poles to each other are opposing.

When electricity is not passed through the coil 2 and an external force is not acting on the vibrator 31, the left side end portion 31a of the vibrator 31 opposes a boundary portion between the upper side opposing face 33a and the lower side opposing face 33b of the magnet 33, and the right side end portion 31b of the vibrator 31 opposes a boundary portion between the upper side opposing face 34a and the lower side opposing face 34b of the magnet 34.

As illustrated in FIG. 4, the first end portion 2a of the coil 2 is connected to the connection terminal 6 that is drawn out to the outside of the exterior casing 3A and that applies the power. Further, the Zener diode 7 that is connected to be parallel with the coil 2 is provided. The second end portion 2b of the coil 2 is drawn out to the outside of the exterior casing 3A, and is connected to the transistor 8 and the diode 9 that configure the driving circuit 5.

In the input detection device 100 illustrated in FIG. 4, the exterior casing 3A of the vibration generation unit 30 functions as an induction member that is arranged in proximity with the coil 2, and the distance between the coil 2 and the inner face of the exterior casing 3A is set to be approximately 0.1 to 1.5 mm.

The lead line 3a that is connected to the exterior casing 3A that is an induction member is connected to the first electrode 11 that configures the input unit 10. The second electrode 12 that opposes the first electrode 11 is connected to the voltage amplification unit 21 of the detection circuit 20. As illustrated in FIG. 3C, since the detection output D1 that is obtained from the peak holding unit 22 is a direct current output (DC output), the detection output D1 is converted into a digital value by an A/D conversion unit 23 and applied to a vibration control unit 25.

The vibration control unit 25 is configured by the CPU of a microcomputer or the like, and includes a level detection unit 26 and a waveform output unit 27 as the main control operations thereof. The waveform of the first driving signal S1 for applying the detection current Ia to the coil 2 and the waveform of the second driving signal S2 for applying the vibration current Ib to the coil 2 are output from the waveform output unit 27. The first driving signal S1 and the second driving signal S2 are provided to an OR circuit 28, and a logical sum output from the OR circuit 28 is provided to the base terminal of the transistor 8 of the driving circuit 5.

The vibration generation unit 30 is arranged on the inner face of the casing of various electronic apparatuses such as mobile communication apparatuses and remote controllers, and the vibrations that are generated by the vibration generation unit 30 can be felt by the hand or the fingers that are holding the casing. The input unit 10 can be operated by an operation member that is provided on the casing. Here, when the input unit 10 is provided on the surface of the exterior casing 3A of the vibration generation unit 30 and the input unit 10 is operated via the operation member, the vibrations that are generated at the vibration generation unit 30 may be passed directly onto the fingers that are operating the operation member.

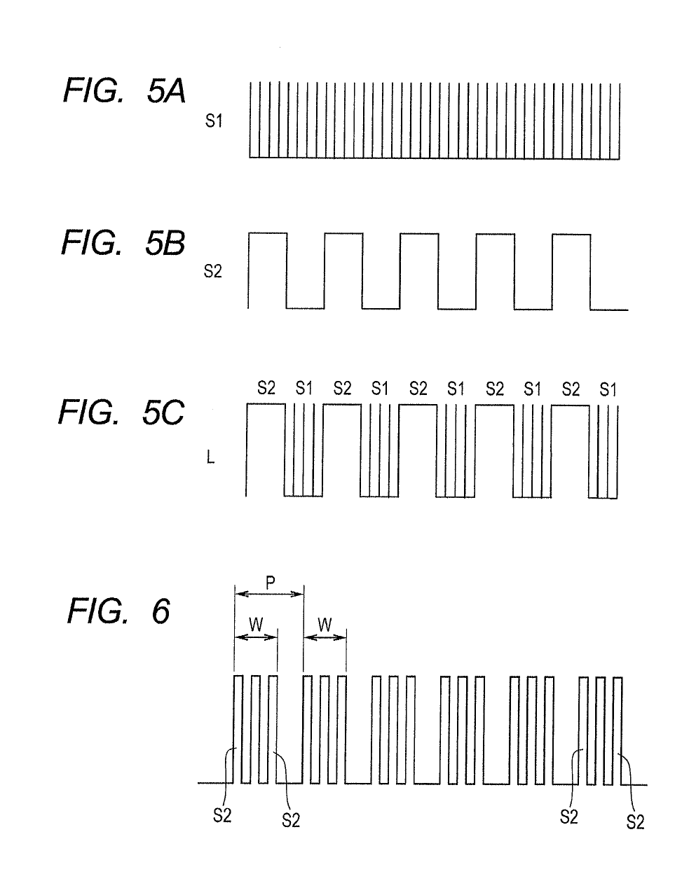

Next, the operation of the input detection device 100 will be described with reference to the waveform view illustrated in FIG. 3 and the waveform view illustrated in FIG. 5.

When the input unit 10 is not operated by the operation member and the opposing distance d and the opposing area A between the first electrode 11 and the second electrode 12 are in the initial state, only the first driving signal S1 illustrated in FIG. 5A is output from the waveform output unit 27 of the vibration control unit 25. The first driving signal S1 has a frequency of equal to or greater than 1 kHz, and is preferably set to a high frequency of approximately 10 kHz to 60 kHz. In the input detection device 100 illustrated in FIG. 4, the first driving signal S1 is set to 32 kHz. The first driving signal S1 illustrated in FIG. 5A is shown with a short pitch for comparison with the second driving signal S2.

In the input detection device 100, when the first driving signal S1 passes through the OR circuit 28 and is provided to the base terminal of the transistor 8, the detection current Ia illustrated in FIG. 3A flows through the coil 2. In the embodiment illustrated in FIGS. 4 and 5, the frequencies of the first driving signal S1 and the detection current Ia are both 32 kHz. Meanwhile, the natural frequency of the vibrator 31 of the vibration generation unit 30 is approximately 50 Hz to 500 Hz, and in the embodiment illustrated in FIG. 5, the natural frequency is 160 Hz. Since the frequency of the detection current Ia is sufficiently higher than the natural frequency of the vibrator 31, even when the detection current Ia flows through the coil 2, the vibrator 31 hardly vibrates.

In order to provide the detection current Ia to the coil 2 without vibrating the vibrator 31, it is necessary for the frequency of the detection current Ia to be equal to or greater than 10 times the natural frequency of the vibrator 31, and is preferably equal to or greater than 50 times.

When the detection current Ia flows through the coil 2 without the vibrator 31 vibrating, the induction power E1 due to the counter-electromotive force illustrated in FIG. 3B is generated on the exterior casing 3A that is an induction member in proximity with the coil 2, and the induction power E1 is led to the first electrode 11 of the input unit 10. When the input unit 10 is not operated by the operation member, the secondary induction power E2 that is inducted to the second electrode 12 does not change, and the peak-held detection output D1 illustrated in FIG. 3C does not change either. The level detection unit 26 of the vibration control unit 25 monitors a level in which the output D1 is converted by an A/D conversion unit into a digital value, and when the change in the level is within a range of a threshold value determined in advance, determines that the input unit 10 is not operated, and continues to output only the first driving signal S1 from the waveform output unit 27.

When it is determined by the level detection unit 26 that the input unit 10 has been operated by the operation member, at least one of the opposing distance d and the opposing area A between the first electrode 11 and the second electrode 12 has changed, the output D1 illustrated in FIG. 3C has changed, and the A/D converted level has changed exceeding the range of the threshold value, the second driving signal S2 illustrated in FIG. 5B is output from the waveform output unit 27. The second driving signal S2 is set to have the same frequency (160 Hz) as the natural frequency or a frequency that approaches thereto so that the vibrator 31 of the vibration generation unit 30 can be vibrated at the natural frequency.

The first driving signal S1 and the second driving signal S2 are provided to the OR circuit 28, and a signal L of the logical sum illustrated in FIG. 5C is output. The first driving signal S1 and the second driving signal S2 are mixed in the signal L. When the signal L is provided to the base terminal of the transistor 8 of the driving circuit 5, both the detection current Ia with a frequency that is equivalent to the first driving signal S1 and the vibration current Ib with a frequency that is equivalent to the second driving signal S2 are applied to the coil 2, and the vibrator 31 is vibrated at the natural frequency or at a frequency that approaches thereto at the timing when the vibration current Ib is applied.

FIG. 6 illustrates a more detailed waveform of the second driving signal S2 that is generated by the waveform output unit 27. The second driving signal S2 that is a pulse waveform with a uniform frequency is continuously output for a width W, and a pulse group of the width W is repeated at a period P. When the vibrator 31 is vibrated with the waveform illustrated in FIG. 6, vibrations with which comparatively large shocks are repeated at the period P are felt by the hand or the fingers of a person who is holding the casing in which the vibration generation unit 30 is installed.

In the input unit 10, as the opposing distance d between the first electrode 11 and the second electrode 12 narrows, the detection output D1 illustrated in FIG. 3C which is output from the peak holding unit 22 is increased. When it is determined by the level detection unit 26 illustrated in FIG. 4 that the level of the detection output D1 has increased, by making the period P of the second driving signal S2 that is output from the waveform output unit 27 proportional to the extent of the level of the detection output D1 and changing the period P of the second driving signal S2, as the opposing distance d between the first electrode 11 and the second electrode 12 narrows, the period of the vibrations that are felt by a hand or fingers can be set to be large.

Further, in the input unit 10, as the deviation amount of the mutual positions of the first electrode 11 and the second electrode 12 increases and the opposing area A between the electrodes decreases, the detection output D1 decreases. When it is determined by the level detection unit 26 illustrated in FIG. 4 that the level of the detection output D1 has decreased, by making the period P of the second driving signal S2 that is output from the waveform output unit 27 inversely proportional to the extent of the level and changing the period P of the second driving signal S2, as the deviation amount between the first electrode 11 and the second electrode 12 increases and the opposing area A decreases, the period of the vibrations that are felt by a hand or fingers can be set to be large.

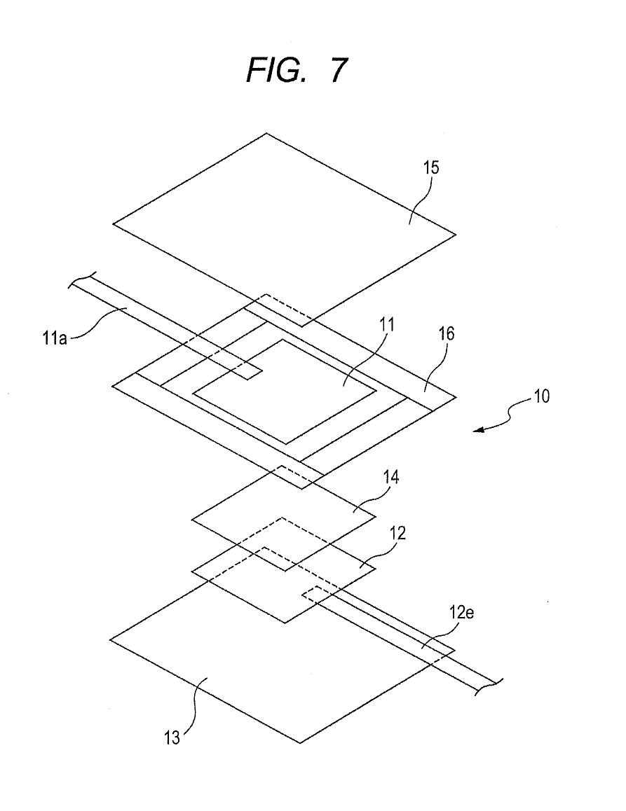

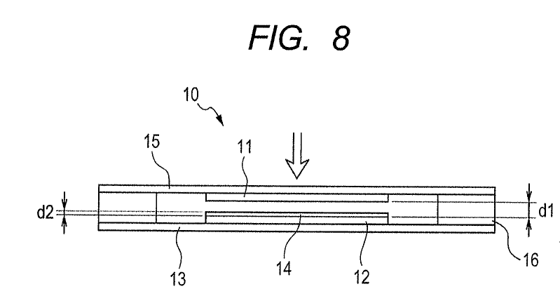

FIGS. 7 and 8 illustrate an example of a detailed structure of the input unit 10 illustrated in FIGS. 1 and 4.

The second electrode 12 is provided fixed on a non-conductive base film 13. The second electrode 12 is a low resistance material layer of a copper foil layer or a silver paste layer. A drawn-out layer 12e that extends from the second electrode 12 is connected to the voltage amplification unit 21 of the detection circuit 20. A non-conductive distance film 14 is adhered to the surface of the second electrode 12.

The first electrode 11 is provided fixed to the lower face of a non-conductive upper portion film 15. The first electrode 11 is formed of the same low-resistance material as the second electrode 12. A drawn-out layer 11a that extends from the first electrode is connected to the lead line 3a illustrated in FIG. 1 or FIG. 4. A non-conductive spacer film 16 is provided on the outer circumference of an opposing region in which the first electrode 11 and the second electrode 12 are opposing, and the base film 13 and the upper portion film 15 are joined via the spacer film 16. The spacer film 16 is a double-sided adhesive tape or the like.

As illustrated in FIG. 8, when no external force is acting on the upper portion film 15, an opposing distance d1 between the first electrode 11 and the second electrode 12 is 50 μm. When the upper portion film 15 is pressed by the operation member and the first electrode 11 is closely adhered to the distance film 14, an opposing distance d2 between the first electrode 11 and the second electrode is 25 μm, which is the thickness dimension of the distance film 14. Here, the first electrode 11 and the second electrode 12 are 4 mm×4 mm squares.

In the input unit 10 illustrated in FIGS. 7 and 8, in a case when the peak value of the voltage of the induction power E1 illustrated in FIG. 3B which is led to the first electrode 11 is 4.2 V, when the opposing distance between the first electrode 11 and the second electrode 12 is d1=50 μm, the peak value of the voltage of the secondary induction power E2 that is led to the second electrode 12 is 0.72 V and the opposing distance d2=25 μm, the peak value of the voltage of the secondary induction power E2 is 1.08 V, and a large detection output can be obtained. If the pressing force that is applied on the upper portion film 15 is adjusted and the opposing distance between the first electrode 11 and the second electrode 12 is changed between dl and d2, the peak value of the output voltage can be changed inversely proportional to the square of the change amount.

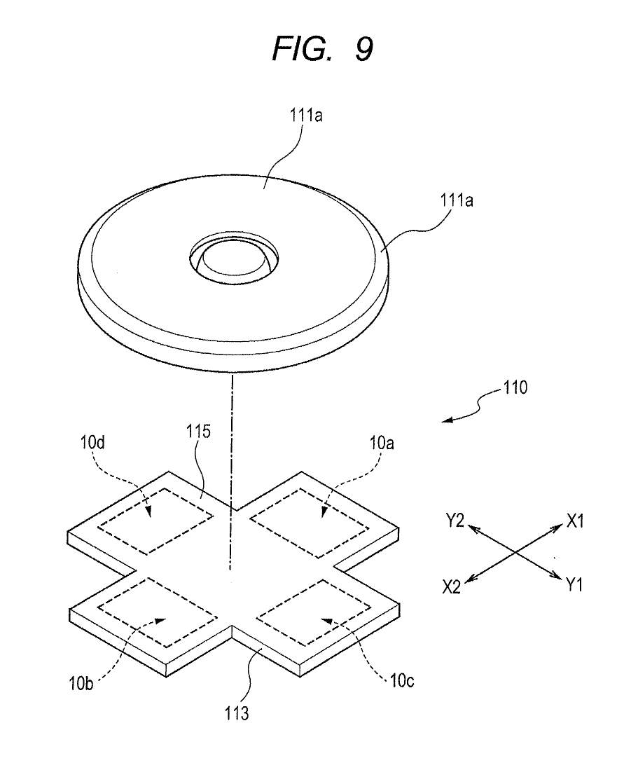

FIG. 9 illustrates an input device 110 that uses the input unit 10 of the structure described above.

A cross-shaped base film 113 and an upper portion film 115 are provided on the input device 110, and input units 10a, 10b, 10c, and 10d are arranged at four locations between the base film 113 and the upper portion film 115. The structures of the respective input units 10a, 10b, 10c, and 10d are the same as those illustrated in FIGS. 7 and 8. A pair of electrodes in which the second electrode 12, the distance film 14, and the first electrode 11 are overlapped is provided between the base film 113 and the upper portion film 115.

An operation member 111 is arranged on the upper portion film 115. The fulcrum of the operation member 111 is on the lower face of a central portion 111a, and the operation member 111 can be tilted in any direction on the X-Y plane.

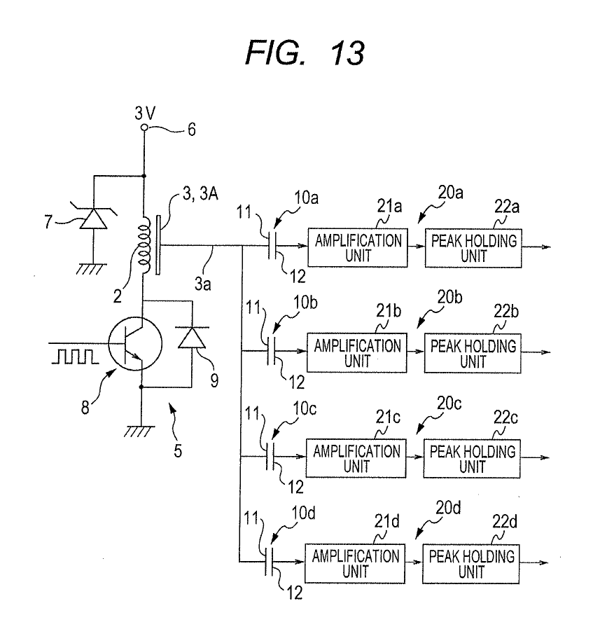

FIG. 13 is a circuit diagram of an input detection device that includes the input device 110. The induction member 3 illustrated in FIG. 1 and the exterior casing 3A illustrated in FIG. 4 are provided in proximity with the coil 2.

The lead line 3a that extends from the induction member 3 or the exterior casing 3A is connected to the respective first electrode 11 of the input units 10a, 10b, 10c, and 10d. The second electrode 12 of the input unit 10a is connected to a detection circuit 20a that includes a voltage amplifier 21a and a peak holding unit 22a. Similarly, the second electrode 12 of the input units 10b, 10c, and 10d is respectively connected to a voltage amplification unit 21b, 21c, and 21d of detection circuits 20b, 20c, and 20d.

In the input device 110 illustrated in FIG. 9, when the operation member 111 is pressed in an X1 direction, the output of the input unit 10a changes according to the magnitude of the pressing force, and when the operation member 111 is pressed in an X2 direction, a Y1 direction, or a Y2 direction, the outputs of the input units 10b, 10c, and 10d respectively change according to the magnitude of the pressing force. The pressing force in each direction within the X-Y plane can be detected by the operation member 111, and a detection output that can change according to changes in the magnitude of the pressing force can be obtained.

Further, similarly to the input device 110 illustrated in FIG. 9, when the variable resistance type input unit 10A illustrated in FIG. 2 is arranged to the X1 side and the X2 side and the Y1 side and the Y2 side, and the operation member 111 is pressed in each direction of X-Y, the input units 10A at the four locations may be individually bent and deformed, and the respective detection output that is obtained from the input units 10A at the four locations may fluctuate.

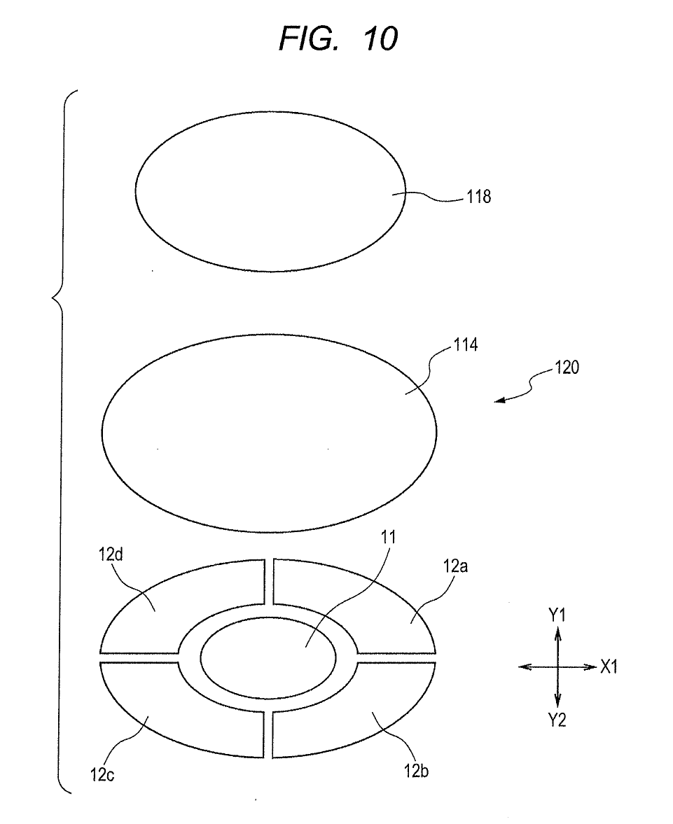

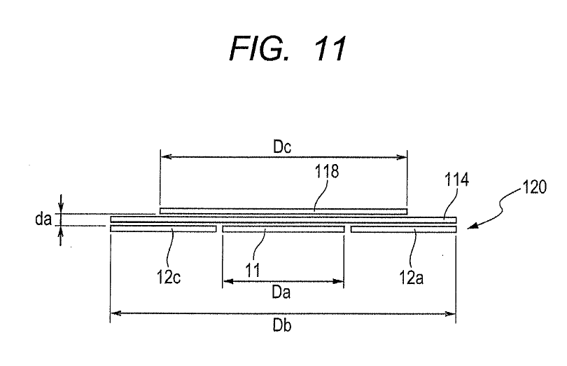

An input device 120 illustrated in FIGS. 10 and 11 has the first electrode 11 provided as a fixed electrode in a central portion, and four second electrodes 12a, 12b, 12c, and 12d are provided on the outer circumference thereof. The first electrode 11 and the second electrodes 12a, 12b, 12c, and 12d are provided on a common non-conductive base film through a printing process or an etching process.

The first electrode 11 is connected to the lead line 3a that extends from the induction member 3 or the exterior casing 3A. The second electrode 12a is connected to the voltage amplification unit 21a of the detection circuit 20a illustrated in FIG. 13, and the second electrodes 12b, 12c, and 12d are respectively connected to the voltage amplification units 21b, 21c, and 21d of the detection circuits 20b, 20c, and 20d.

The input device 120 has a non-conductive distance film 114 laid over the first electrode 11 and the second electrodes 12a, 12b, 12c, and 12d, and a movable electrode 118 is provided thereon. The movable electrode 118 is formed of the same low-resistance material as the first electrode 11 and the second electrodes 12a, 12b, 12c, and 12d. The movable electrode 118 is provided on the bottom face of an operation member that is disk-shaped or the like. By operating the operation member, the movable electrode 118 can be slid in the respective X-Y directions in a state of maintaining an opposing distance da between the first electrode 11 and the second electrodes 12a, 12b, 12c, and 12d.

In the input device 120 illustrated in FIGS. 10 and 11, a diameter Da of the first electrode 11 is 8 mm, a diameter Db of the outer rim of the second electrodes 12a, 12b, 12c, and 12d that are arranged in a ring shape is 20 mm, and a diameter Dc of the movable electrode 118 is 15 mm. Further, the opposing distance da between the movable electrode 118, the first electrode 11, and the second electrodes 12a, 12b, 12c, and 12d is 25 μm.

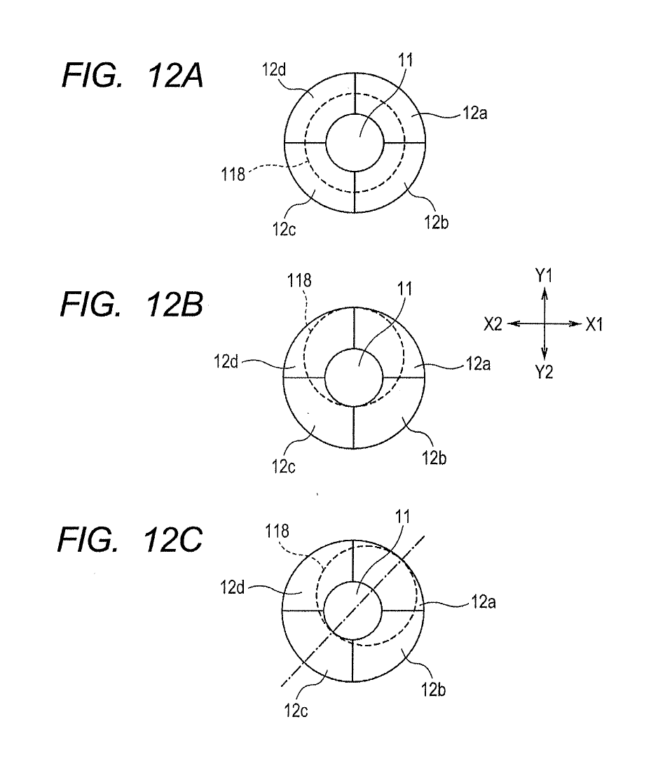

FIG. 12 illustrates an input operation state in which the movable electrode 118 is slid in each direction. If the peak value of the voltage of the induction power E1 that is inducted to the induction member 3 or the exterior casing 3A is 4.2 V, when the movable electrode 118 is in the center as illustrated in FIG. 12A, the peak value of the secondary induction power E2 that is inducted to the second electrodes 12a, 12b, 12c, and 12d is 0.38 V.

As illustrated in FIG. 12B, if the center of the movable electrode 118 has moved in the Y1 direction, the peak value of the voltage of the secondary induction power E2 that is inducted to the second electrodes 12a and 12d is 0.45 V, and the peak value is 0.34 V at the second electrodes 12b and 12c.

As illustrated in FIG. 12C, if the center of the movable electrode 118 has moved at an angle of 45 degrees with respect to both the X1 direction and the Y1 direction, the peak value of the secondary induction power E2 of the second electrode 12a is 0.5 V, 0.4 V for the second electrodes 12b and 12d, and 0.32 V for the second electrode 12c.

As described above, in the input device 120, a detection output corresponding to the sliding direction of the movable electrode 118 and fluctuations in the sliding distance can be obtained.

In the input device 110 illustrated in FIG. 9, as illustrated in FIG. 4, if the induction power E1 is led from the exterior casing 3A of the vibration generation unit 30, for example, as the pressing force of the operation member 111 in each direction is increased and the opposing distance d between the first electrode 11 and the second electrode 12 is decreased, vibration control such as gradually increasing the vibration period P illustrated in FIG. 6 is possible.

Similarly, in the input device 120 illustrated in FIGS. 10 and 11, as the movable electrode 118 is moved in a direction away from the center, vibration control such as gradually increasing the vibration period P illustrated in FIG. 6 is possible.

It should be understood by those skilled in the art that various modifications, combinations, sub-combinations and alterations may occur depending on design requirements and other factors insofar as they are within the scope of the appended claims of the equivalents thereof.

What is claimed is:

1. An input detection device comprising:
a coil;
a conductive induction member that is provided in proximity to the coil;
a driving circuit that applies an alternating detection current to the coil;
a detection circuit that detects power that is inducted to the induction member by a counter-electromotive force when the detection current is applied to the coil; and
an input unit that increases or decreases the power that is obtained from the induction member.

2. The input detection device according to claim 1, further comprising:
a vibration generation unit that includes the coil, and
a vibration control unit that generates vibrations on the vibration generation unit by applying an alternating vibration current to the coil when an output from the detection circuit changes.

3. The input detection device according to claim 2, wherein a waveform output unit that generates a first driving signal that generates the detection current on the driving circuit and a second driving signal that generates the vibration current on the driving circuit is provided on the vibration control unit.

4. The input detection device according to claim 3,
wherein the vibration current comprises an alternating current with a frequency that matches or approaches a natural frequency of the vibration generation unit, and the detection current comprises an alternating current with a frequency that is higher than the natural frequency.

5. The input detection device according to claim 4,
wherein in the vibration control unit, a logical sum of the first driving signal and the second driving signal is provided to the driving circuit.

6. The input detection device according to claim 5,
wherein the induction member comprises a casing that contains the vibration generation unit.

7. The input detection device according to claim 6,
wherein the input unit includes a first electrode that is conductive with the induction member and a second electrode that opposes the first electrode, and
a change in a power of the second electrode when at least one of a change in an opposing distance between the first electrode and the second electrode and a change in an opposing area therebetween changes is detected by the detection circuit.

8. The input detection device according to claim 7,
wherein the input unit comprises a pair of electrodes which include the first electrode and the second electrode provided at a plurality of locations, and an operation member that selectively operates the plurality of electrode pairs.

9. The input detection device according to claim 3,
wherein in the vibration control unit, a logical sum of the first driving signal and the second driving signal is provided to the driving circuit.

10. The input detection device according to claim 2,
wherein the induction member comprises a casing that contains the vibration generation unit.

11. The input detection device according to claim 1,
wherein the input unit includes a first electrode that is conductive with the induction member and a second electrode that faces the first electrode, and
a change in a power of the second electrode when at least one of a change in a distance between the first electrode and the second electrode and a change in an facing area therebetween changes is detected by the detection circuit.

12. The input detection device according to claim 11,
wherein the input unit comprises pairs of electrodes that include the first electrode and the second electrode at a plurality of locations, and an operation member that selectively operates the plurality of electrode pairs.

13. The input detection device according to claim 1,
wherein the input unit includes a variable resistance unit that is provided between the induction member and the detection circuit.

14. The input detection device according to claim 13,
wherein the input unit comprises the variable resistance unit provided at a plurality of locations, and an operation member that selectively changes the plurality of variable resistance units.

15. The input detection device according to claim 1,
wherein the input unit includes a first electrode, a plurality of second electrodes that are respectively connected to the detection circuit, and a movable electrode that selectively faces the first electrode and the plurality of second electrodes.
